(19) United States
(12) Patent Application Publication
(10) Pub. No.: US 2024/0054419 A1
(43) Pub. Date: Feb. 15, 2024

(54) SITE MONITORING ACTIVITY REVIEW TOOL (ART)

(71) Applicant: IQVIA Inc., Durham, NC (US)

(72) Inventors: Lars Jonas Mikael Renstroem, Uppsala (SE); Eric Celestin Henri Leray, Raleigh, NC (US)

(21) Appl. No.: 17/883,975

(22) Filed: Aug. 9, 2022

(51) Int. Cl. G06Q 10/06; G06N 20/00

(52) U.S. Cl. CPC G06Q 10/0633; G06Q 10/06312; G06Q 10/0635; G06N 20/00

(57) ABSTRACT

A method comprises training a machine-learning system using one or more mitigation actions to apply to one or more encountered risks and identifying tasks to be completed onsite. The method also includes monitoring site workflow using the trained machine learning system to identify the tasks to be completed and the one or more risks that occur onsite. The method further comprises reporting findings from the site monitoring to a reporting visit site as the site monitoring is being performed.

### FIELD OF INVENTION

Embodiments disclosed herein relate, in general, to a site monitoring activity review tool (ART) system that provides site monitoring and reporting in real-time.

### BACKGROUND

Studying monitoring pricing and work delivery to customers has been based on source data verification (SDV) activity at the site. The SDV activity at the site consists of data transcription accuracy verification between the source documents at the site and its transcript. The transcription can include the case report form or electric data capture. Moreover, recently study conduct and oversight strategy have trended toward risk-based monitoring (RBM) strategy.

RBM strategy focuses on monitoring study specific data points and processes. In the RBM model, the site monitoring focuses on reviewing essential process compliance to the protocol and the regulations. Source data review (SDR) is part of the RBM model that applies to all critical processes executed under the protocol beyond those captured in the electronic data capture. As long as the SDV was sufficiently representative of monitoring work programs, the SDR was not required to be tracked.

With the RBM model, the SDV dropped below the SDR percentage. As such, the SDV is no longer representative of monitoring progress. As a result, the clinical research industry in general cannot demonstrate site-monitoring activity progress to customers and regulators that is in compliance with industry regulations.

Other current solutions track targeted SDV, and enable a partial selection of data points in their electronic data capture to make a closer match to the RBM strategy for site-monitoring. Nevertheless, the SDV is reduced to an insignificant portion of the site monitoring, and the electronic data capture data represents only a part of the data collected in a trial.

Accordingly, there is a need to be able to track SDR or effectively translate site work progress to accurate forecasting of resources needed. Moreover, there is a need for a tool to capture monitoring time at a granular level to enable AI/ML productivity variance analysis.

### SUMMARY

Embodiments of the present invention provide a computing device implemented method. The method includes training a machine learning system using one or more mitigation actions to apply to one or more encountered risks and identifying tasks to be completed onsite. The method also includes monitoring site workflow using the trained machine learning system to identify the tasks to be completed and the one or more risks that occur onsite. In addition, the method includes reporting findings from the site monitoring to a reporting visit site as the onsite monitoring is being performed.

Embodiments in accordance with the present invention, the method also includes generating task completion data as a result of the site monitoring.

Further, the method also includes establishing an adjusted task list for one or more upcoming visits based on the site monitoring.

Further, embodiments of the present invention may provide a computer program product comprising a tangible storage medium encoded with processor-readable instructions that, when executed by one or more processors, enable the computer program duct to train a machine learning system using one or more mitigation actions to apply to one or more encountered risks and identifying tasks to be completed onsite. The computer program product is also enabled to monitor site workflow using the trained machine learning system to identify the tasks to be completed and the one or more risks that occur onsite. Further, the computer program product can report findings from the site monitoring to a reporting visit site as the site monitoring is being performed.

Further, embodiments of the present invention may provide the computer program product, wherein the reported findings include process reviews of one or more workflows to the reporting visit site.

Further, embodiments of the present invention may provide the computer program product, wherein the report includes information on timeliness of completion of one or more workflows.

Embodiments of the present invention may provide a computing system connected to a network. The computing system can include one or more processors configured to train a machine learning system using one or more mitigation actions to apply to one or more encountered risks and identifying tasks to be completed onsite. The one or more processors can also monitor site workflow using the trained machine learning system to identify the tasks to be completed and the one or more risks that occur onsite. Further, the one or more processors can also report findings from the site monitoring to a reporting visit site as the site monitoring is being performed.

In embodiments of the present invention, the site monitoring includes an event schedule that is agreed upon by the one or more customers.

In embodiments of the present invention, the site monitoring includes one or more embedded cheat sheets.

The preceding is a simplified summary to provide an understanding of some embodiments of the present invention. This summary is neither an extensive nor an exhaustive overview of the present invention and its various embodiments. The summary presents selected concepts of the embodiments of the present invention in a simplified form as an introduction to the more detailed description presented below. As will be appreciated, other embodiments of the present invention are possible utilizing, alone or in combination, one or more of the features set forth above or described in detail below and also illustrated in the figures described below.

### BRIEF DESCRIPTION OF THE DRAWINGS

The above and still further features and advantages of embodiments of the present invention will become apparent upon consideration of the following detailed description of embodiments thereof, especially when taken in conjunction with the accompanying drawings, and wherein:

FIG. 1 illustrates an system according to an embodiment of the invention;

FIG. 2 illustrates an ART system according to an embodiment of the present invention;

FIG. 3 illustrates features of an ART system according to embodiments of the present invention;

FIG. 4 illustrates exemplary features according to embodiments of the present invention; and

FIG. 5 illustrates a flowchart of the features of the ART system according to embodiments of the present invention.

### DETAILED DESCRIPTION

The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include”, “including”, and “includes” mean including but not limited to. To facilitate understanding, like reference numerals have been used, where possible, to designate like elements common to the figures.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The term “dataset” may be used broadly to refer to any data or collection of data, inclusive of but not limited to structured data (including tabular data or data encoded in JSON or other formats and so on), unstructured data (including documents, reports, summaries and so on), partial or subset data, incremental data, pooled data, simulated data, synthetic data, or any combination or derivation thereof. Certain examples are depicted or described herein in exemplary sense without limiting the present disclosure to other forms of data or collection of data.

Present features of the invention relate developing a site-monitoring plan at a reporting visit to enable real-time reporting of site monitoring to occur at a project site. The real-time reporting of what occurs onsite can enable the reporting visit center to identify the efficiency at which work is completed at the site. The real-time reporting can see the completions times data of the completed tasks, and what tasks need to be completed on later visits. Further, the reporting visit site can obtain progress reports on the workflow at the site and on the tasks that were completed.

To enable the real-time reporting at the site with the site monitoring, the reporting visit site/site visit report can develop the plan needed to provide site monitoring onsite at site that include tasks to be performed on a visit. The site-monitoring plan can factor into account the protocol risks at the site. The protocol risks can include the potential issues that can occur when monitoring the workflow and completing the risks. The site-monitoring plan can also include a risk assessment mitigation plan (RAMP) that determines how potential risks at the site can be mitigated given the risks that can occur at the site. In addition, the site-monitoring plan can also include an event schedule. One or more customers can agree on the particular event schedule that should be used at the site. As such, the site-monitoring plan can be put together using the protocol risks, RAMP and event schedule.

After the site monitoring plan is completed, an artificial intelligence (AI)/machine learning (ML) can be trained using the inputted site-monitoring plan. The input data can be the protocol risks, event schedule, and RAMP that are used to put together the site-monitoring plan. As such, the AI/ML model is trained with the site-monitoring plan. As a result, a user can access the online application on his/her mobile device to apply the trained AI/ML model that includes the site-monitoring plan. The AI/ML synthesizes large data volume. In addition, the AI/ML predicts output in a substantially reduced time period, wherein the time period can be just seconds. The AI/ML predicts the output in a substantially reduced timeframe than what could be performed by humans in a cloud-computing platform.

When the user is at the site, the user can access the application on his/her mobile device. The user device may be, but not limited to, a mobile device, a smart phone, a tablet computer, a portable computer, a laptop computer, a desktop computer, a smart device, a smart watch, a smart glass, a Personal Digital Assistant (PDA), and so forth. Embodiments of the present invention are intended to include or otherwise cover any type of the user device, including known, related art, and/or later developed technologies.

The application will include the site-monitoring plan to perform the site-monitoring review at the site. The user can identify the subject data and the tasks that are to be completed on the visit to-do list. The user can also monitor the workflow at the site. When tasks on the to-do list are completed, a clock stop feature can generate the task completion times data for the completed task. The task completion times data can be reported to the reporting visit site in real-time.

The site-monitoring review is performed by applying the trained AI/ML model based on the site-monitoring plan. The user at the site can complete the charts that indicate the completion of the tasks. In addition, the user can complete the charts based on the completed site visit report (SVR)/clinical trial management system (CTMS)/AI/productivity development (PD). The user can report these completed tasks in real-time. Further, the user can send progress reports that include the completed tasks and workflow to the reporting visit site in real-time. The user can also report to the reporting visit site what tasks were not completed, and that need to be completed on one or more subsequent visits to the site.

Activity review tool (ART) data modeling outcomes can be used based on the data captured from the site monitoring review. Multi-factorial analysis on AI/ML models can be used, wherein the input data can be captured data from the site monitoring review, and wherein the AI/ML models are trained by using the captured data from the site monitoring review. The trained AI/ML models can lead to forecasting. From the forecasting, there can be an adaptive pricing model and a predictive monitoring resourcing model. From the forecasting, there can also be a productivity improvement modeling and assessment, and site quality improvement modeling.

The applied site monitoring plan and site monitoring review can provide an AI/ML driven data analytics as a product. Deliver to contract and embedded cheat sheets through guidance and support can be provided. Detailed quality data through data granularity and reporting flows with process reviews by a reporting time saver can also be provided. Further, real-time reporting on captured data is provided onsite with reporting timeliness and risk based monitoring (RBM) of quality proficiency is provided, wherein data mining on monitoring of quality proof points are intended to be provided to regulatory authorities and customers. Further, productivity control is provided. Process review time to capture and grow detailed knowledge on monitoring tasks and completion variances is provided. In addition, improvement opportunities in relation to productivity are sought after as well.

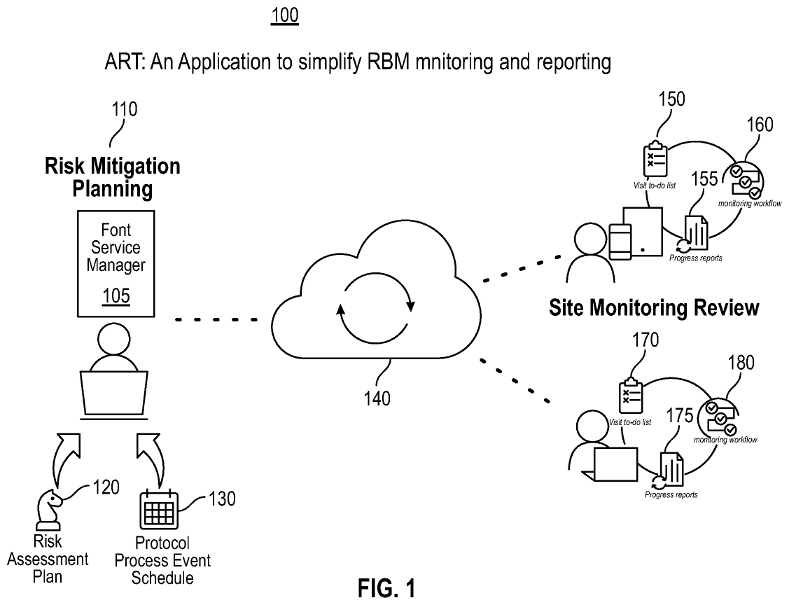

Referring to FIG. 1, an ART ML resource data system (system) 100. The system 100 can be an artificial intelligence/machine-learning system. In other embodiments, the system 100 can be within a network such as a neural network, deep-learning network, and or convolutional neural network in one or more embodiments. The system 100 is trained to use a site-monitoring plan that includes a RAMP and a protocol subject visit plan. One or more users can plan a site-monitoring plan. The site-monitoring plan will therefore include a RAMP, a protocol subject visit plan to complete and identify tasks onsite, and an event schedule that has been agreed upon by one or more customers, and also will account for the protocol risks. As such, the system 100 is trained to utilize the planned site-monitoring plan.

In FIG. 1, the system 100 includes a font service manager 105 along with risk mitigation planning 110. The user can perform the risk mitigation planning 110 at a standard workstation connected to the system 100 within the network. The user can include a risk assessment plan 120 and protocol process event schedule 130. The user and workstation can be connected to the system 100 and a cloud like network 140. Using the cloud network 140, the user can put together the risk mitigation planning 110 using the risk assessment plan 120 and the protocol process event schedule 130, and then provide the risk mitigation planning 110 through the cloud network 140 to provide the site monitoring review.

Referring to FIG. 1, the site monitoring review can include a visit-to-do list 150, 170, monitoring workflow 160, 180, and progress reports 155, 175. The visit-to-do list 150, 170 includes all of the tasks that need to be performed and completed. The tasks that are not completed or unfinished are placed in the reports. The monitoring workflow 160, 180 includes monitoring the completion of tasks and other activities that are occurring at the work-site. The reporting of the monitoring workflow 160, 180 occurs in real-time. The progress reports 155, 175 will include what tasks were completed and what tasks need to be completed on a subsequent visit based on what was completed from the visit to-do list 150, 170. The progress reports 155, 175 any information on the site from the monitoring workflow 160, 180. The progress reports 155, 175 will report the completed, and unfinished tasks that the status of the activities at the site. Moreover, the progress reports 155, 175 will report the tasks completed, unfinished tasks, and status of tasks at the site to a reporting visit site that produced the site-monitoring plan.

In FIG. 1, in summary, a system 100 within an AI/ML network can include the risk mitigation planning 110. A user at a workstation can plan the risk mitigation planning 110 using the risk assessment plan 120 and protocol process event schedule 130. The user or users can provide the risk mitigation planning 110 through the cloud network 140 to enable the site monitoring review to be performed. The site monitoring review will be performed on site and reported back to the reporting visit site in real-time. The visit to-do list 150, 170 will be identified and performed in real-time. Any unfinished tasks on the visit-to-do list 150, 170 will be identified and provided in the progress reports 155, 175 provided to the reporting visit site. The monitoring workflow 160, 180 will identify the tasks being performed an all activities that are occurring. The progress reports 155, 175 will be provided back to the reporting visit site that includes all of information acquired from the visit to-do list 150, 170 and the monitoring workflow 160, 180.

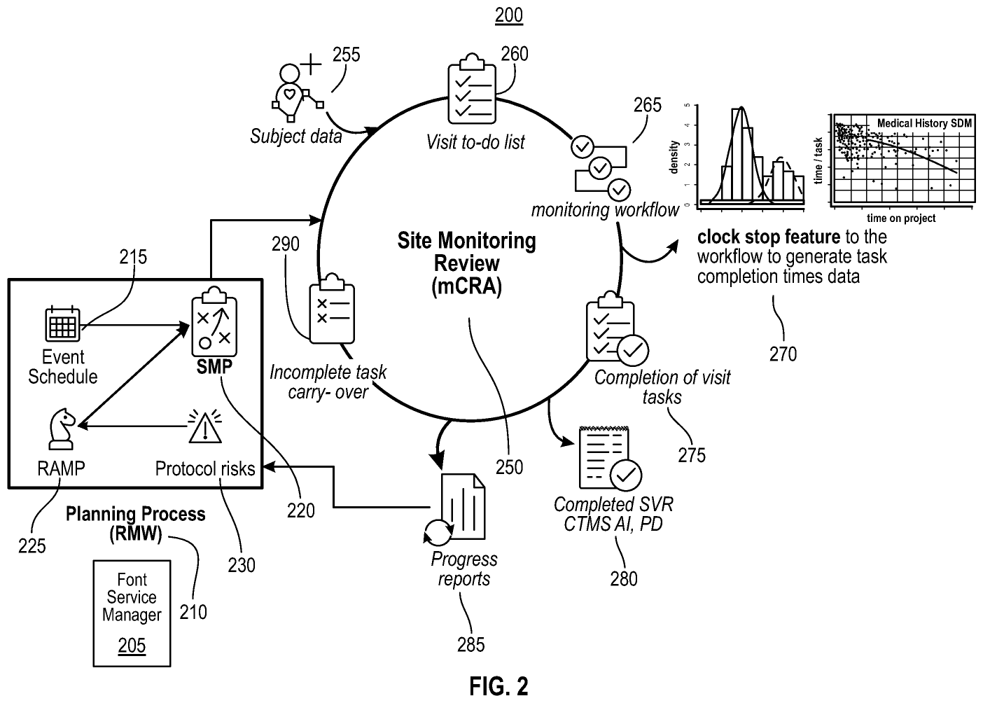

Referring to FIG. 2, a system 200 substantially similar to that of FIG. 1 is illustrated. The inner functioning of the system 200 in FIG. 2 is described in more detail than what was illustrated in FIG. 1.

With respect to FIG. 2, a planning process 210 occurs based on the risk mitigation work (RMW) or planning at a reporting visit site. A font service manager 205 will be used in conjunction with the planning process 210. The planning process 210 includes an event schedule 215. The event schedule 215 will be the schedule that is agreed upon by one or more customers. The event schedule 215 can lead to the site-monitoring plan (SMP) 220. Further, the planning process 210 also includes protocol risks 230. The protocol risks 230 include the various risks that can occur onsite with the site monitoring review. The planning process 210 also includes a risk assessment mitigation plan (RAMP) 225. The RAMP 225 includes mitigation actions to take in place of any encountered risks. As such, the protocol risks 230, RAMP 225, and the event schedule 215 are used to make the SMP 220 that is to be provided on site for the site-monitoring plan. A user at a workstation at the site visit report can undergo the planning process 210. The user and one or more customers can identify the protocol risks 230 associated with the SMP 220. Further, the user can determine the RAMP 225 and agree on the event schedule 215 with the one or more customers. When the SMP 220 is complete, the user can provide the SMP 220 to an onsite worker to perform the site monitoring review 250.

Referring to FIG. 2, the monitor can utilize an application on a mobile device to access the SMP 220 that has been determined at the site visit report and provided to the user. While onsite, the user can identify a variety of issues in real-time, and provide progress reports 285 to the site visit report which provided the SMP 220. The SMP 220 includes the user onsite identifying the subject data 255. Further, the user can also move onto a visit to-do list 260. The visit to-do list 260 includes the tasks and/or activities that need to be completed onsite in relation to the site monitoring review 250. The site monitoring review 250 also includes monitoring workflow 265 that occurs onsite in real-time. Using the application on the mobile device, the user can use the SMP 220 that enables for monitoring workflow 265 in relation to the site monitoring review 250. The monitoring workflow 265 can include identifying what tasks on the visit to-do list 260 that are being completed or that need to be completed. When tasks are completed, task completion times can be generated using the clock stop feature 270. The clock stop feature 270 will generate task completion times data of the completed tasks in real-time. For instance, the clock stop feature 270 can factor into account medical history and the time on the project when generating the completion times data. The monitoring workflow 265 also includes completion of visit tasks 275. The completion of visit tasks 275 can be reported to the reporting visit site in real time. Moreover, each of the steps in the site monitoring review 250 will be performed in real-time. The user can also proceed to the completed site visit report (SVR/clinical trial management system (CTMS)/AI/PD 280.

In FIG. 2, in real-time, progress reports 285 are made of the site monitoring review 250. A full cycle of the site monitoring review 250 does not need to be completed for the progress reports 285 to be made. In other words, as the user onsite passes thru the subject data 255 to the completed SVR/CTMS AL, PD 280, the user is sending progress reports 285 of completed tasks and any issues of workflow. Moreover, the user, through the mobile application on the mobile device, is sending progress reports 285 of the completion of visit tasks 275. The user is also sending completion times data from the clock stop feature 270 via the progress reports 285. As tasks are being completed, the user can send the progress reports 285 to the reporting visit site in real-time. Any incomplete task(s) 290 and/or carry-over tasks that were not completed, and which need to be completed on a subsequent visit are identified as well.

Referring to FIG. 2, in summary, a planning process 210 includes identified protocol risks 230, RAMP 225, and the event schedule 215 agreed to by the one or more customers. The SMP 200 is then provided. A user on his mobile device accesses the application that includes the SMP 220 while the user is onsite. The site monitoring review 250 is performed at the site. The subject data 255 is identified and the tasks that need to be performed are identified on the visit to-do list 260. The user monitoring workflow 265 is identified as well and reported in real-time back to the reporting visit site that underwent the planning process 210. When tasks on the visit-to-to-list 260 are completed, a clock stop feature 270 generates task completion times data. The tasks completion times data of the tasks are reported back to the reporting visit site in real-time as they occur. Once tasks are completed from the visit-to-do list 260, the completion of visit tasks 275 are noted as well. Further, the completed SVR/CTMS/AI/PD 280 tasks are also noted when completed. The site monitoring review 250 also includes progress reports 285 that are sent back to the reporting visit site in real-time. The progress reports 285 will include the completed tasks, the completion times data of the tasks, and also the unfinished or complete tasks 290 that need to be completed on a subsequent visit.

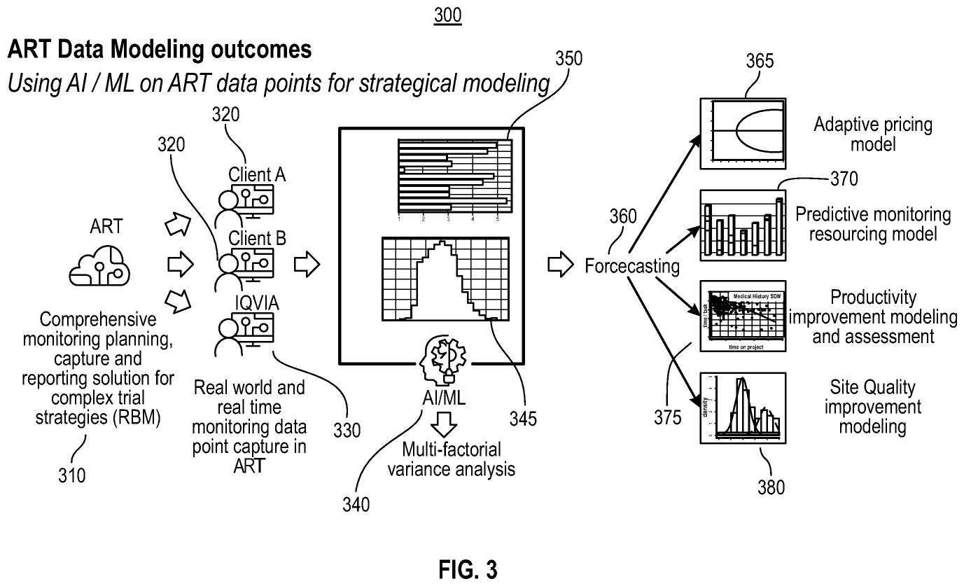

In FIG. 3, activity review tool (ART) data modeling outcomes 300 are illustrated. The ART data modeling outcomes 300 include comprehensive monitoring, planning, capture, and reporting of complex trial strategies 310. The planning can occur at the reporting visit site and can include the protocol risks, risk mitigation plan and event schedule. The site monitoring review will include identifying a to-do list to be completed on that visit. The site monitoring review will also include generating completion times data for the completed tasks and also noting the tasks completed that also include the SVR and CTMS. Further, the site monitoring review also includes providing progress reports in real-time on the completed tasks and on the workflow at the site. Further, the reporting will also include reporting any unfinished tasks at the site that need to be completed on a future visit.

Referring to FIG. 3, a real world and real time monitoring and data point capture 310 is also shown. As such, all of the tasks that need to be completed can be reported back to the reporting visit site. Further, the tasks that are completed, and the times in which the tasks are completed, including the types of tasks completed (SRV/CTMS/PD etc.) are reported in real-time. The data point capture 310 will occur for a multitude of clients 320, 330 (A, B, Iqvia). Once the site monitoring plan is put together, the client/user can access the site monitoring plan on his/her mobile device, and then capture data points in real-time, and report the data points back to the reporting visit site in real-time.

In FIG. 3, a multi-factorial analysis 340 is illustrated. The multi-factorial analysis 340 is shown to include AI/ML in real-time. The AI/ML strategic models 345, 350 receive an input of the captured data points from the site monitoring review, wherein the site monitoring review was made on the RAMP (described in FIGS. 1-2 or the planning process. As such, the real-time data from the completed tasks, and monitoring of the workflow, and uncompleted data is inputted into the models 345, 350. Essentially, the AI/ML models 345, 350 are trained using the inputted captured data from the site monitoring review which the user has performed onsite.

In FIG. 3, forecasting 360 is shown as the output from the trained AI/ML models 345, 350, wherein the time it takes for monitors to finish the processes they are assigned are tracked accordingly. The forecasting 360 incudes adaptive pricing model 365, a predictive monitoring resourcing model 370, a productivity improvement modeling and assessment 375, and site quality improvement modeling 380. The adaptive pricing model 365 can refer to the pricing of putting together the site-monitoring plan based on the protocol risks, event schedule, and RAMP discussed above. Further, the adaptive pricing model 365 can also include the cost of executing the site monitoring onsite. In other words, the cost can refer to going through the subject data, the to-do list, and also generating the completion times data and completing the checklist for the tasks completed and SVR and CTMS related tasks. In addition, the adaptive pricing model can also factor into account the progress reports to the reporting visit site and the cost for completing the unfinished tasks on subsequent visits.

Referring to FIG. 3, the predictive monitoring resource model 370 will refer to the planning that occurs at the reporting visit site, wherein the planning includes the protocol risks, the calendar which customers agreed upon, and the RAMP that goes into the planning phase. In addition, the unfinished tasks that occur onsite which need to be completed on subsequent visits also can be included into the predictive monitoring resource model 370.

In FIG. 3, the productivity improvement modeling and assessment 375 includes identifying the efficiency in which the tasks are completed onsite via the site monitoring review and the efficiency of the monitoring workflow. The productivity improvement modeling and assessment 375 also can identify the completion times data and the time it takes to complete the tasks on the to-do list. In addition, the productive improvement modeling and assessment 375 can identify the how many of the tasks are completed in comparison to how many of the tasks are not completed and need to be completed on a subsequent visit.

With respect to FIG. 3, the site quality improvement modeling 380 can include improving the efficiency of completing the tasks on the to-do list and the efficiency of the monitoring workflow. The site quality improvement modeling 380 can also include improving the time required to provide the progress reports in real-time to the reporting visit site. The site quality improvement modeling 380 can also involve improving the monitoring of the workflow for the user while the user is onsite performing the site monitoring review.

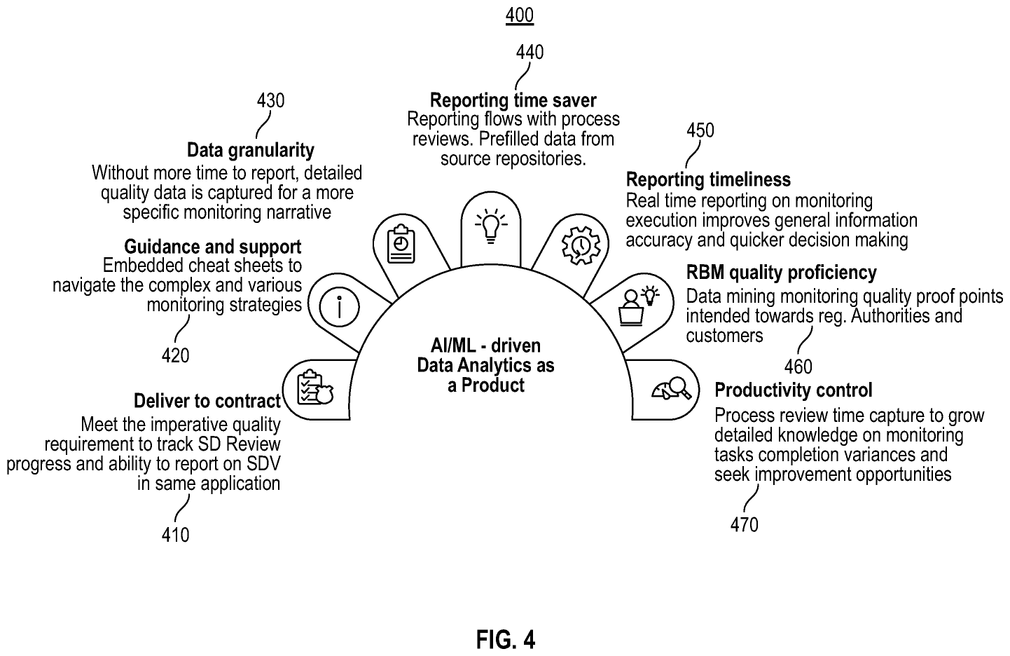

In FIG. 4, chart 400 is illustrated of the benefits that the system described in FIGS. 1-3 can provide. The chart 400 involves AI/ML driven data analytics as a product. Deliver to contract 410 is shown. With deliver to contract 410, the imperative quality requirement involves tracking source data review progress. The deliver to contract 410 also includes the ability to report on source data variance in the same application. The variance in the source data review is identified.

Referring to FIG. 4, guidance and support 420 is also provided. The guidance and support 420 includes embedded cheat sheets to navigate the complex and various monitoring strategies. The completed tasks and uncompleted tasks are reported in real-time. The completion times of the tasks are provided in real-time. As such, a constant reporting of the site monitoring onsite is reported to the reporting visit site in real-time.

In FIG. 4, data granularity 430 is also illustrated. With data granularity 430, without more time to report the data at the site monitoring, detailed quality data is captured in real-time for a more specific monitoring narrative. The completion times of the data and tasks are reported in real-time with the clock stop feature at the site monitoring review site. The checklist of the tasks in relation to the data are completed and reported in real-time.

Referring to FIG. 4, reporting time saver 440 is shown. The reporting time saver 440 reports flows with process reviews. The site monitoring workflow is reported in real-time to the reporting visit site. Tasks that are being completed from the to-do list are reported, and tasks that are not completed are reported in real-time. Prefilled data from source repositories are also included. The prefilled data from source repositories can include the completed data onsite from source repositories that are onsite at the site monitoring review.

In FIG. 4, reporting timeliness 450 is illustrated. Reporting timeliness 450 includes real-time reporting on monitoring execution. Generation information accuracy and quicker decision making is improved. The completion times data of the completed tasks is accurately reported in real-time. The tasks that are not completed are reported on task reports and reported to the reporting visit site in real-time. The progress and efficiency of the monitoring of the workflow is more accurately reported in real-time.

With respect to FIG. 4, risk based monitoring (RBM) quality proficiency 460 is also shown. The RBM quality proficiency 460 includes data mining monitoring quality. The RBM quality proficiency 460 also includes proof points intended toward authorities and customers. Overall, the RBM quality proficiency 460 overall will include the mine the data at the site monitoring site and report the mined data to customers and authorities.

Referring again to FIG. 4, productivity control 470 is also illustrated. The productivity control 470 will include process review time at the site monitoring site. The review time it takes to capture and grow detailed knowledge on the data and completed tasks onsite is included in the productivity control 470. The productivity control 470 also includes monitoring task completion variances. The task completion variance include the tasks that are completed on the to-do list and the tasks on the to-do list that could not be completed and need to be completed on subsequent visits. The improvement opportunities within the productivity control 470 include identifying methods and systems to monitor the workflow and complete the tasks on the to-do list more efficiently. The productivity control 470 can also include the efficiency in which the completed tasks and completion times data are reported in real-time to the reporting visit site.

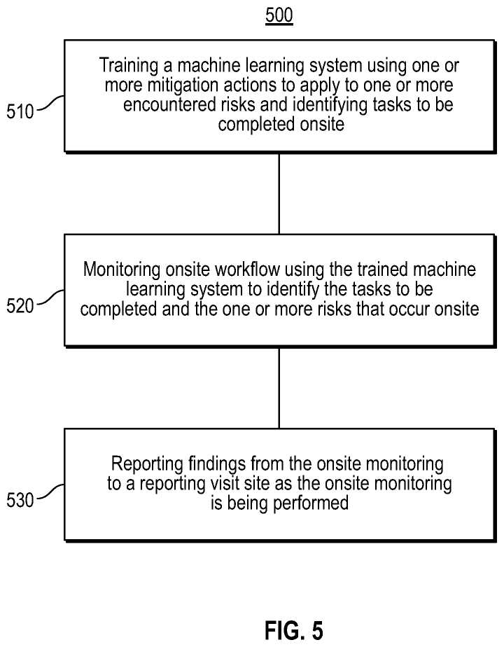

In FIG. 5, a method 500 illustrated the site monitoring plan is described. The method 500 has substantially similar features and descriptions to FIGS. 1-4.

In FIG. 5, at step 510, a site-monitoring plan is planned at a reporting visit site. The ART machine-learning system is trained using one or more mitigation actions from the RAMP. The ART machine-learning system is also trained to identify tasks to be completed onsite using the protocol subject visit plan. As such, the site-monitoring plan includes a RAMP and protocol subject visit plan. Further, the site-monitoring plan can also include protocol risks and an event schedule that one or more customers have agreed to use. Overall, the computation model will be an AI/ML model that is trained to provide the site-monitoring plan using the risk assessment mitigation plan, protocol subject plan, the identified protocol risks, and the agreed upon event schedule. The input data to train the AI/ML model will be the risk assessment mitigation plan, protocol subject plan, identified protocol risks, and event schedule.

Referring to FIG. 5, at step 520, workflow is monitored onsite using the trained ART machine-learning system. The site monitoring includes identifying the tasks to be completed onsite and the one or more risks that occur onsite.

In FIG. 5, at step 530, findings from the site monitoring are reported to the reporting visit site as the site monitoring is being performed. The site monitoring (or site monitoring review) is performed onsite by a user using the trained AI/ML model. The user locates the application on his/her mobile device that has the site monitoring plan. The site monitoring review is performed using the trained computational model that includes the RAMP, protocol subject plan, protocol risks, and event schedule that have been agreed upon by one or more customers. Onsite, the executed site-monitoring review will include performing tasks on the to-do list. In addition, the executed site-monitoring review will include generating and reporting the completions time data using a clock stop feature in real-time. The applied site monitoring review will include monitoring workflow onsite, and identifying the tasks that have not been completed. Further, charts or lists can be made that indicate the tasks that need to be completed on subsequent visits to the site. The site monitoring review can also include completed charts of the tasks completed from the visit to-do list.

Referring to FIG. 5, in relation to step 530, findings from the site monitoring are reported in real-time. The user provides progress reports onsite to the site visit report. The progress reports will include the tasks that were completed on the visit to-do list, and also the workflow occurring on the site. The progress reports can also include the completion times data of the tasks. Further, the progress reports will also include the unfinished tasks that need to be completed on one or more subsequent visits.

Overall, the site-monitoring review described in FIGS. 1-5 provides many advantages. To summarize, the site-monitoring plan can be put together by one or more users at a reporting visit site. The site-monitoring plan can include the RAMP, protocol subject visit plan, protocol risks, and event schedule that one or more customers have agreed upon. As such, the site monitoring plan is put together that takes into account the potential risk involved onsite, and provides the site monitoring plan that compensates and mitigates the risks that are involved.

The site-monitoring plan can be utilized to train a AI/ML computational model using the inputted site-monitoring plan that includes the RAMP, protocol subject visit plan, event schedule, and protocol risks. When the user accesses the site monitoring application on his/her mobile device the user is onsite, the user is able to use the trained computational model to apply the site-monitoring plan onsite. The AI/ML synthesizes large data volume and predicts outputs in a cloud-computing platform in much less time than that of one or more users.

When the user is onsite, the user will perform the site monitoring review by completing the tasks on the visit to-do list, and then reporting the completion times data of the tasks in real-time. A clock stop feature will enable the user to generate and report the completions times data of the completed tasks in real time. The charts of completed tasks can also be completed onsite. The completed charts will also include the completed SVR/CTMS/AI/PD related tasks. The user can also generate progress reports of all of the completed tasks and also report on the monitored workflow onsite. Further, the user is able to identify the tasks which have not been completed and which need to be completed on subsequent visits.

The effect of the reported data from the site monitoring review can include a multi-factorial variance analysis. Forecasting that includes an adaptive pricing model and a predictive monitoring resource model can occur. The forecasting can also include a productivity improvement modeling and assessment and site quality improvement modeling.

The site monitoring review can deliver to contract and track source data review and report on source data variance. Embedded cheat sheets to navigate the complex and various monitoring strategies by guidance and support can be provided. Data granularity is obtained, wherein detailed quality data is captured for a more specific monitoring narrative. Reporting flows with process reviews and prefilled data from source repositories by a reporting time saver is also obtained. The timeliness of reporting also occurs with the real-time reporting on monitoring execution. The accuracy of the information is improved and decisions are made more efficiently. RBM also occurs in which data mining monitoring quality intended for regulatory authorities and customers is provided. Further, productivity control occurs with monitoring task completion variances and with seeking improvements in how to complete the tasks efficiently.

Overall, the site-monitoring plan including RAMP, the protocol subject visit plan, protocol risks and event schedule can be put together at the site visit report. An AI/ML model can be trained to perform the site-monitoring plan onsite. The user can perform all of the necessary tasks onsite and report when the tasks have been completed to the reporting visit site in real-time. Further, the user can also report on the efficiency of the workflow onsite, and also identify which tasks need to be completed in future visits in real-time. As such, the site-monitoring plan enables the user to report what is occurring onsite to the reporting visit site in real-time. The user is able to generate reports of completed tasks in real-time, and also report on the workflow at the site in real-time, and identify what tasks need to be completed at a later visit in real-time. The captured data can be used for multi-factorial variance analysis, which can lead to forecasting. In addition, important features such as deliver to contract, guidance and support (embedded cheat sheets), data granularity, a reporting time saver, timeliness in reporting, RBM quality proficiency, and productivity control are provided.

The present invention, in various embodiments, configurations, and aspects, includes components, methods, processes, systems and/or apparatus substantially as depicted and described herein, including various embodiments, sub-combinations, and subsets thereof. Those of skill in the art will understand how to make and use the present invention after understanding the present disclosure.

The present invention, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease and/or reducing cost of implementation.

While the foregoing is directed to embodiments of the present disclosure, other and further embodiments of the present disclosure may be devised without departing from the basic scope thereof. It is understood that various embodiments described herein may be utilized in combination with any other embodiment described, without departing from the scope contained herein. Further, the foregoing description is not intended to be exhaustive or to limit the disclosure to the precise form disclosed.

Modifications and variations are possible in light of the above teachings or may be acquired from practice of the disclosure. Certain exemplary embodiments may be identified by use of an open-ended list that includes wording to indicate that the list items are representative of the embodiments and that the list is not intended to represent a closed list exclusive of further embodiments. Such wording may include “e.g.,” “etc.,” “such as,” “for example,” “and so forth,” “and the like,” etc., and other wording as will be apparent from the surrounding context.

What is claimed is:

1. A computing device implemented method, the method comprising:
training a machine learning system using one or more mitigation actions to apply to one or more encountered risks and identifying tasks to be completed onsite;
monitoring site workflow using the trained machine learning system to identify the tasks to be completed and the one or more risks that occur onsite; and
reporting findings from the site monitoring to a reporting visit site as the site monitoring is being performed.

2. The computing device implemented method of claim 1, further comprising:
generating task completion data as a result of the site monitoring.

3. The computing device implemented method of claim 1, wherein the training includes building a site-specific process review plan.

4. The computing device implemented method of claim 1, wherein the site monitoring includes reporting workflows with process reviews.

5. The computing device implemented method of claim 1, wherein the site monitoring includes leveraging a data warehouse with subject data and progress of a visit.

6. The computing device implemented method of claim 1, further comprising:
establishing an adjusted task list for one or more upcoming visits based on the site monitoring.

7. The computing device implemented method of claim 1, further comprising:
reporting protocol deviations based on the performed site monitoring.

8. A computer program product comprising a tangible storage medium encoded with processor-readable instructions that, when executed by one or more processors, enable the computer program product to:
train a machine learning system using one or more mitigation actions to apply to one or more encountered risks and identifying tasks to be completed onsite;
monitor site workflow using the trained machine learning system to identify the tasks to be completed and the one or more risks that occur onsite; and
report findings from the site monitoring to a reporting visit site as the site monitoring is being performed.

9. The computer program product of claim 8, wherein the reported findings include process reviews of one or more workflows to the reporting visit site.

10. The computer program product of claim 8, wherein the report includes information on data mining in relation to regulatory authorities and customers.

11. The computer program product of claim 8, wherein the site monitoring includes monitoring one or more tasks that have to be performed.

12. The computer program product of claim 8, wherein the site monitoring includes monitoring which tasks have been completed and which tasks need to be performed.

13. The computer program product of claim 8, wherein the report includes information on timeliness of completion of one or more workflows.

14. The computer program product of claim 8, wherein the reporting includes reporting any incomplete activity to be completed at a later interval.

15. A computing system connected to a network, the system comprising:
one or more processors configured to:
train a machine learning system using one or more mitigation actions to apply to one or more encountered risks and identifying tasks to be completed onsite;
monitor site workflow using the trained machine learning system to identify the tasks to be completed and the one or more risks that occur onsite; and
report findings from the site monitoring to a reporting visit site as the site monitoring is being performed.

16. The computing system of claim 15, wherein the site monitoring includes an event schedule that is agreed upon by the one or more customers.

17. The computing system of claim 15, wherein the site monitoring includes one or more embedded cheat sheets.

18. The computing system of claim 15, wherein the report of the findings includes identifying which tasks on a to-do list were not completed.

19. The computing system of claim 15, wherein the report of the findings includes identifying which tasks need to be completed in another site monitoring performance.

20. The computing system of claim 15, wherein a risk assessment mitigation plan and protocol subject visit plan are agreed upon by one or more customers.
